(19) United States
(12) Patent Application Publication
(10) Pub. No.: US 2012/0126016 A1
(43) Pub. Date: May 24, 2012

(54) PLANAR ANTENNA HAVING RFID ELECTRIC TAGS

(75) Inventors: Tsai-Yi YANG, Kuntien Hsiang (TW); Wei-Hung Hsu, Kuntien Hsiang (TW); Hsin-Chia Huang, Kuntien Hsiang (TW)

(73) Assignee: Cirocomm Technology Corp.

(21) Appl. No.: 12/949,667

(22) Filed: Nov. 18, 2010

(51) Int. Cl. G06K 19/077

(52) U.S. Cl. 235/492

(57) ABSTRACT

A planar antenna having RFID electric tags comprises: a substrate (1), a radiating metal layer (2), a grounding metal layer (3) and a RFID chip (4). The substrate (1) has a front surface (11) and a rear surface (12) thereon. The radiating metal layer (2) is provided on the front surface (11) of the substrate (1). The grounding metal layer (3) is provided on the rear surface (12) of the substrate (1). The RFID chip (4) is provided on the front surface (11) of the substrate (1). The RFID chip (4) has a plurality of pins (41) on its two sides. The pins (41) electrically connect to the radiating metal layer (2) and the grounding metal layer (3). The planar antenna (10) having RFID electric tags of the invention may be used in the aspects of a metal surface and merchandise with a larger metal surface and liquid merchandise without interference when a RFID reader reads data.

### BACKGROUND OF THE INVENTION

1. Field of the Invention

The invention relates to a RFID electric tag, and more particularly, to a planar antenna having a function of RFID electric tag.

2. Description of Prior Art

RFID electric tags have been widely used in the logistics area. It may store data related to merchandise, credit card or access card on a RFID chip. When RFID reader reads the data, the action of merchandise payment, merchandise inventory management, credit card usage and identity identification, etc. can be finished.

A traditional method for manufacturing RFID electric tags comprises first preparing a plastic sheet, providing a reception and emission antenna on the plastic sheet, gluing a RFID chip on the plastic sheet and electrically connecting the pins and the antenna. When finishing the manufacture of the RFID electric tags, adhesives may be directly coated on a surface of plastic sheet having the antenna and RFID chip so that the RFID electric tags may be adhered to merchandise.

The traditional RFID electric tags have a deficiency of susceptible to ambient factors, such as usage in the water or liquid and high humid environment, easily causing interference and diffraction. Alternative, when providing traditional RFID electric tags on a surface of metal, it may cause high ratio of error of reading data.

### SUMMARY OF THE INVENTION

It is a main object of the invention to improve the above deficiency of the traditional RFID electric tags by a combination of RFID chip and planar antenna. The larger the area of the grounding metal layer of the planar antenna is, the better reception the planar antenna is. Therefore, the planar antenna having a RFID electric tag can be used in the aspects of a metal surface and merchandise with a larger metal surface and liquid merchandise without interference when a RFID reader reads data.

The object described above is achieved by a planar antenna having a RFID electric tag of the invention. The planar antenna having a RFID electric tag comprises: a substrate made of ceramic material, the substrate having a front surface and a rear surface thereon; a radiating metal layer provided on the front surface of the substrate, the radiating metal layer having an area which is equal to or less than the area of the front surface of the substrate, the radiating metal layer having at least a first electrode on its one side; a grounding metal layer provided on the rear surface of the substrate, the grounding metal layer having an area which is equal to or less than the area of the rear surface of the substrate, the grounding metal layer having at least a second electrode on its one side which extends to the front surface of the substrate; a RFID chip provided on the front surface of the substrate, the RFID chip having a plurality of pins on its two sides, the pins electrically connecting to the first electrode and the second electrode.

### BRIEF DESCRIPTION OF THE DRAWINGS

FIG. 1 is an exploded view of planar antenna and RFID chip of the invention.

FIG. 2 is an assembly view of planar antenna and RFID chip of the invention.

FIG. 3 is a schematic rear view of the planar antenna.

FIG. 4 is a top view of the planar antenna of the invention.

FIG. 5 is a schematic cross-sectional view along line 5-5 of FIG. 4.

FIG. 6 shows the usage state of the planar antenna of the invention.

FIG. 7 is another embodiment of the invention.

FIG. 8 is a schematic side-sectional view of FIG. 7.

FIG. 9 is a schematic top view of a further embodiment of the planar antenna of the invention.

FIG. 10 is a schematic bottom view of a further embodiment of the planar antenna of the invention.

### DETAILED DESCRIPTION OF THE INVENTION

A preferred embodiment of the present invention will be described with reference to the drawings.

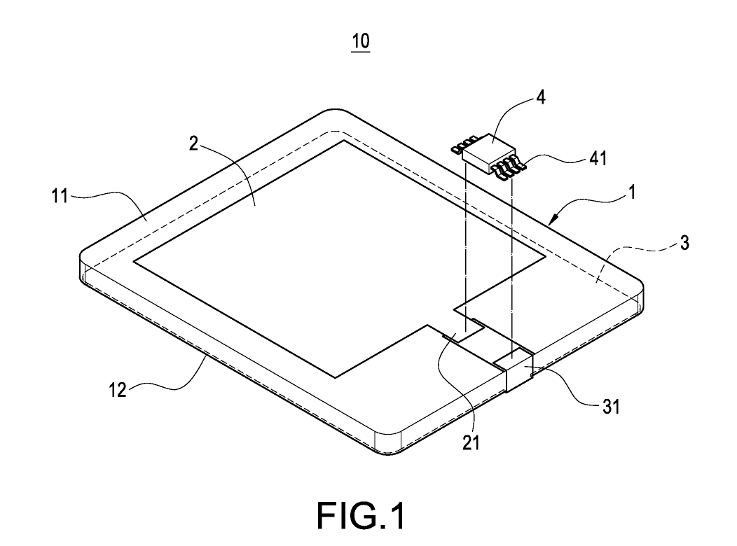

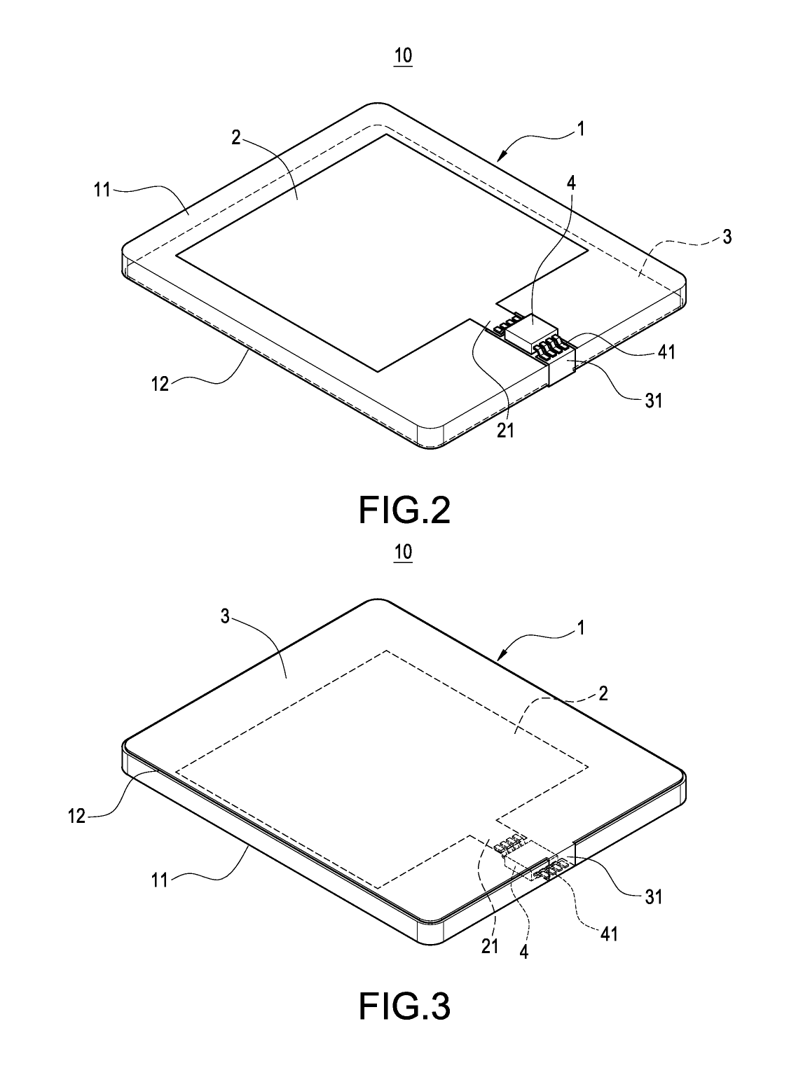

Please refer to FIGS. 1, 2 and 3. FIG. 1 is an exploded view of planar antenna and RFID chip of the invention. FIG. 2 is an assembly view of planar antenna and RFID chip of the invention. FIG. 3 is a schematic rear view of the planar antenna. As shown in the drawings, the invention relates to a planar antenna 10 having RFID electric tags comprising: a substrate 1, a radiating metal layer 2, a grounding metal layer 3 and a RFID chip 4.

The substrate 1 is made of ceramic material to present a square or rectangular body, and has a front surface 11 and a rear surface 12 thereon.

The radiating metal layer 2 is provided on the front surface 11 of the substrate 1. The radiating metal layer 2 may be used for signal reception and emission. Also, the radiating metal layer 2 has an area which is equal to or less than the area of the front surface 11 of the substrate 1. The radiating metal layer 2 has at least a first electrode (microstrip) 21 on its one side.

The grounding metal layer 3 is provided on the rear surface 12 of the substrate 1 for grounding. The grounding metal layer 3 has an area which is equal to or less than the area of the rear surface 12 of the substrate 1. The grounding metal layer 3 has at least a second electrode 31 on its one side which extends to the front surface 11 of the substrate 1.

The RFID chip 4 may be made by a well-known art. The RFID chip 4 is provided on the front surface 11 of the substrate 1. The RFID chip 4 has a plurality of pins 41 on its two sides to electrically connect to the first electrode 21 and the second electrode 31. The RFID chip 4 may receive a signal radiated from an external RFID reader (not shown in the drawings) by the radiating metal layer 2, and transmitting the signal of RFID chip 4 to the RFID reader.

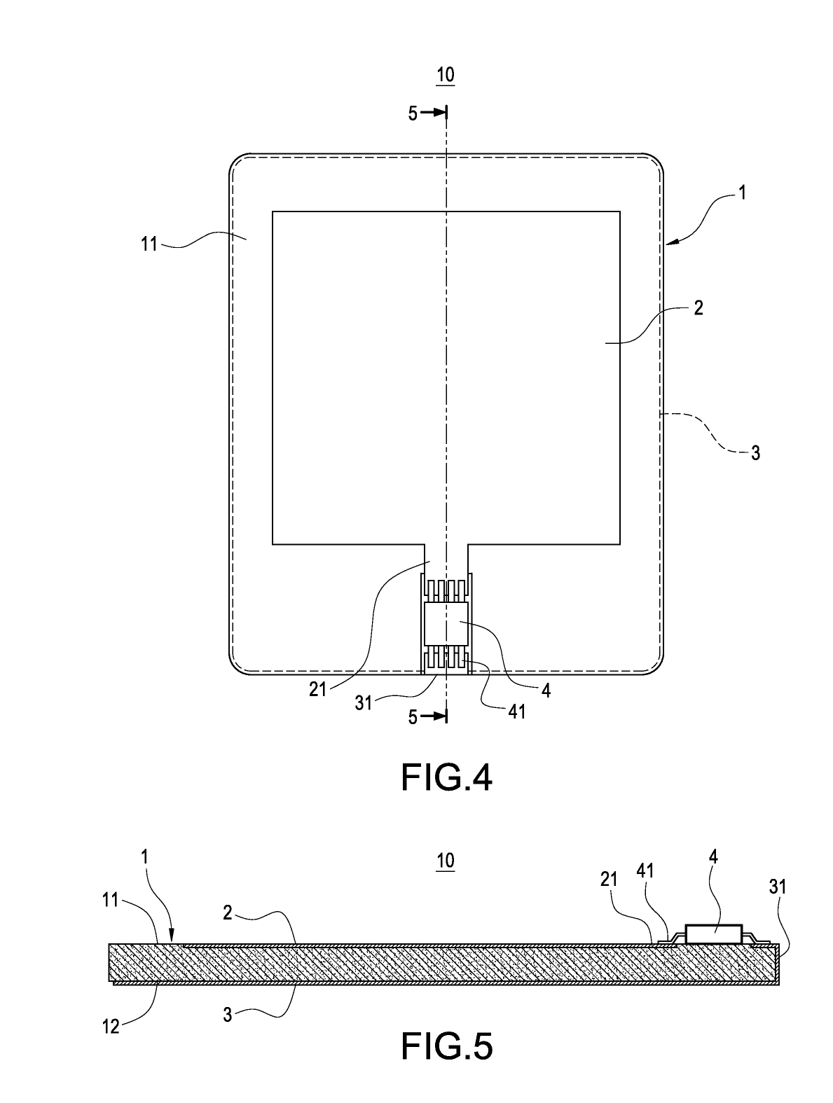

Please refer to FIGS. 4 and 5. FIG. 4 is a top view of the planar antenna of the invention. FIG. 5 is a schematic cross-sectional view along line 5-5 of FIG. 4. As shown in the drawings, the substrate 1 has the radiating metal layer 2 provided on the front surface 11, and has the grounding metal layer 3 provided on the rear surface 12. The RFID chip 4 connects a first electrode 21 of the radiating metal layer 2 and a second electrode 31 of the grounding metal layer 3. Since the RFID chip 4 is provided on the planar antenna 10, the larger the area of the grounding metal layer 3 of the planar antenna 10 is, the better reception the planar antenna 10 is. Therefore, the RFID electric tag can be used in the merchandise with a larger metal surface (not shown in the drawings) without interference during reception and emission of signal. It is different with traditional RFID electronic tags which cannot be used in a metal merchandise with greater volume.

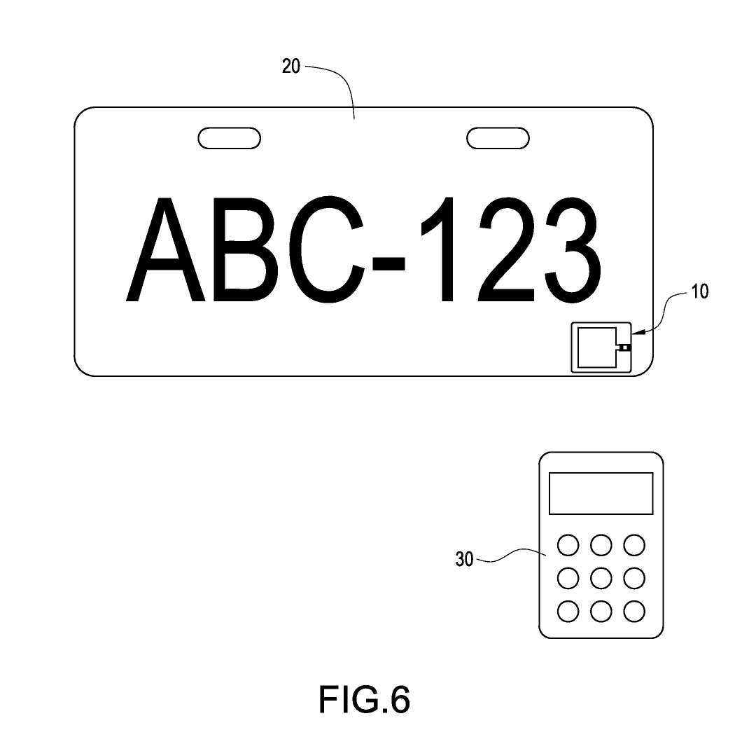

Please also refer to FIG. 6, which shows that the planar antenna 10 having a RFID electric tag is provided on a metal license plate 20 of a vehicle. After the grounding metal layer 3 of the rear surface 12 of the substrate 1 contacts with the metal license plate 20, the grounding area is enlarged to improve the reception and emission of the planar antenna 10 without interference from a metal object during reception and emission of signal. Therefore, the external RFID reader 30 can read the data stored in the RFID chip 4.

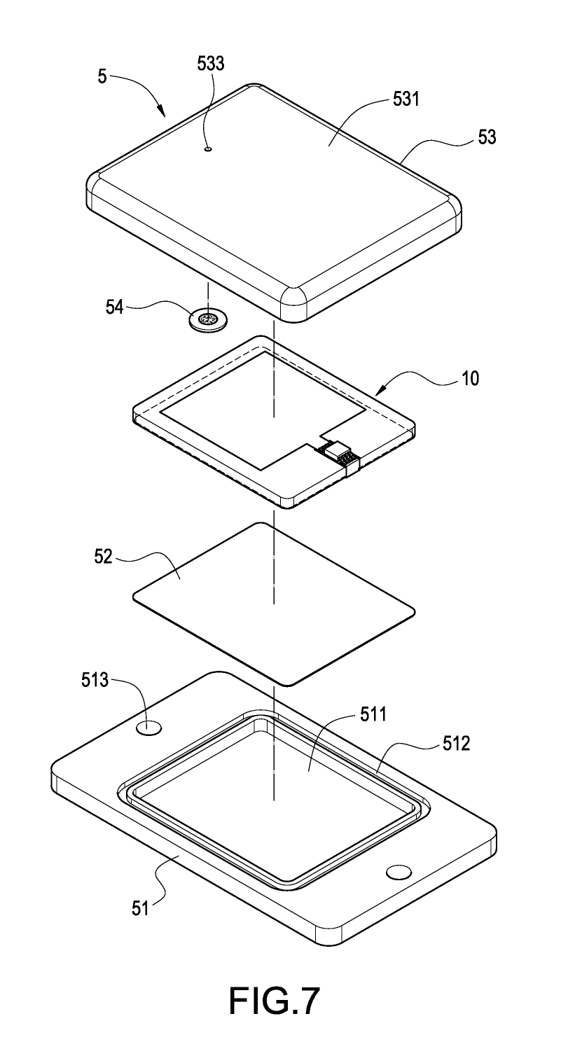

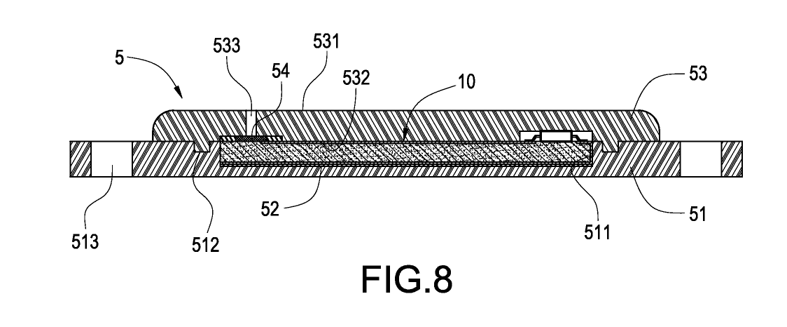

Please also refer to FIGS. 7 and 8. FIG. 7 is another embodiment of the invention. FIG. 8 is a schematic side-sectional view of FIG. 7. As shown in the drawings, after finishing the manufacture of the planar antenna having a RFID electric tag of the invention, the planar antenna 10 can be provided in a housing 5 made of plastics. The housing 5 comprises a base 51, a gummed tape 52, a cover 53 and an adhesive tape 54 with waterproof property and vapor permeability.

The base 51 has a chamber 511 for receive the planar antenna 10 therein. The chamber 511 has a groove 512 around the edge for connecting the cover 53. When connecting to the cover 53, a sealing strip or glue coating can be provided in the groove 512 to have a waterproof effect. In addition, the base 51 has joint holes 513 on two sides of the chamber 511, corresponding to each other. The joint holes 513 can be used for fastening the base 51 to the metal object. Alternative, a double-sided tape can be provided on the rear surface of the base 51 to adhere on the object directly.

The gummed tape 52 is a double-sided tape or an adhesive which is used for adhering the planar antenna 10 within the chamber 511.

The cover 53 is inserted into the groove 512. The cover 53 has an outer surface 531 and an inner surface 532. The outer surface 531 has a vent 533 penetrating through the cover 53.

The adhesive tape 54 with waterproof property and vapor permeability is provided on the inner surface 532 of the cover 53 to seal the vent 533. The adhesive tape 54 can prevent the external moisture from entering the chamber 511, while exhausting the moisture within the chamber 511 to keep the chamber 511 dry.

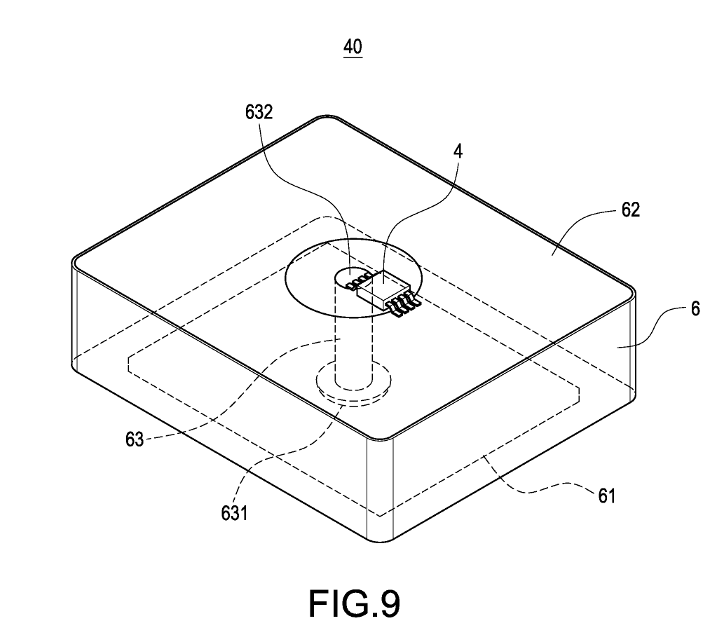

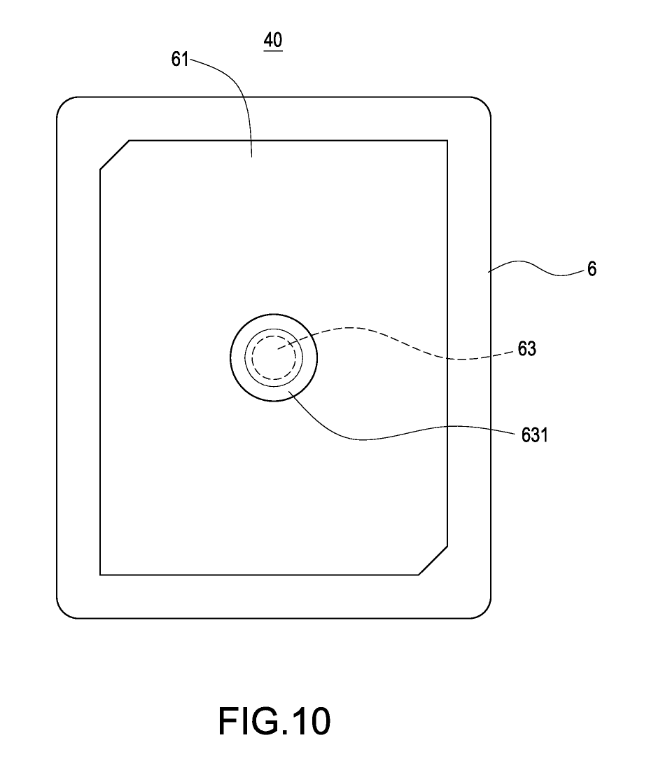

Please refer to FIGS. 9 and 10. FIG. 9 is a schematic top view of a further embodiment of the planar antenna of the invention. FIG. 10 is a schematic bottom view of a further embodiment of the planar antenna of the invention. As shown in the drawings, another type of the planar antenna 40 of the invention has a cubic substrate 6 made of ceramic material. The substrate 6 has a radiating metal layer 61 on the front surface and a grounding metal layer 62 on the rear surface. The substrate 6 has a signal feeding body 63 penetrating through per se. The signal feeding body 63 has a first end 631 electrically connecting to the radiating metal layer 61 and a second end 632 penetrating through a bottom of the substrate 6. The second end 632 may not contact with the grounding metal layer 62. There is a RFID chip 4 electrically connecting the second end 632 to the grounding metal layer 62 to form another type of a planar antenna having RFID electric tags.

Although the present invention has been described with reference to the foregoing preferred embodiment, it will be understood that the invention is not limited to the details thereof Various equivalent variations and modifications can still occur to those skilled in this art in view of the teachings of the present invention. Thus, all such variations and equivalent modifications are also embraced within the scope of the invention as defined in the appended claims.

What is claimed is:

1. A planar antenna having RFID electric tags comprising:
a substrate (1) having a front surface (11) and a rear surface (12) thereon;
a radiating metal layer (2), provided on the front surface (11) of the substrate (1);
a grounding metal layer (3) provided on the rear surface (12) of the substrate (1); and
a RFID chip (4) provided on the front surface (11) of the substrate (1), the RFID chip (4) having a plurality of pins (41) on its two sides, the pins (41) electrically connecting to the radiating metal layer (2) and the grounding metal layer (3).

2. The planar antenna of claim 1 wherein the substrate (1) is made of ceramic material, and the substrate (1) is a square body or a rectangular body.

3. The planar antenna of claim 1 wherein the radiating metal layer (2) has an area which is equal to or less than the area of the front surface (11) of the substrate (1), the radiating metal layer (2) having at least a first electrode (21) on its one side, the first electrode (21) electrically connecting to the pins (41) on a side of the RFID chip (4).

4. The planar antenna of claim 1 wherein the grounding metal layer (3) has an area which is equal to or less than the area of the rear surface (12) of the substrate (1), the grounding metal layer (3) having at least a second electrode (31) on its one side, the second electrode (31) extending to the front surface (11) of the substrate (1), the second electrode (31) electrically connecting to the pins (41) on another side of the RFID chip (4).

5. The planar antenna of claim 1 further comprising a plastic housing (5) enclosing the planar antenna (10), the housing (5) comprising:
a base (51) having a chamber (511) for receive the planar antenna (10) therein, the chamber (511) having a groove (512) around the edge; and
a cover (53) inserted into the groove (512), the cover (53) having an outer surface (531) and an inner surface (532), the outer surface (531) having a vent (533) penetrating through the cover (53).

6. The planar antenna of claim 5 wherein when connecting the groove (512) to the cover (53), a sealing strip or glue coating can be provided in the groove (512) to have a waterproof effect.

7. The planar antenna of claim 5 wherein the base (51) has joint holes (513) on two sides of the chamber (511), corresponding to each other, a gummed tape (52) provided on the chamber (511) of the base (51), the gummed tape (52) is a double-sided tape or an adhesive which is used for adhering and fixing the planar antenna (10) within the chamber (511).

8. The planar antenna of claim 5 further comprising an adhesive tape (54) with waterproof property and vapor permeability, the adhesive tape (54) being provided on the inner surface (532) of the cover (53) to seal the vent (533).

9. A planar antenna having RFID electric tags comprising:
a substrate (6) having radiating metal layer (61) on a front surface and a grounding metal layer (62) on a rear surface, the substrate (6) having a signal feeding body (63) penetrating through per se, the signal feeding body (63) having a first end (631) electrically connecting to the radiating metal layer (61) and a second end (632) penetrating through a bottom of the substrate (6), the second end (632) not to contact with the grounding metal layer (62); and
a RFID chip (4) electrically connecting the second end (632) and the grounding metal layer (62).

10. The planar antenna of claim 9 wherein the substrate (6) is ceramic material, the substrate (6) is a cube.
